(19) United States
(12) Patent Application Publication
(10) Pub. No.: US 2009/0185323 A1
(43) Pub. Date: Jul. 23, 2009

(54) OVERHEAT PROTECTION CIRCUIT

(76) Inventors: Kiyoshi Yoshikawa, Chiba-shi (JP); Toshiyuki Koike, Chiba-shi (JP); Shohei Tsukamoto, Chiba-shi (JP); Kazuaki Sano, Chiba-shi (JP); Fumihiko Maetani, Chiba-shi (JP); Wataru Sakamoto, Chiba-shi (JP); Atsushi Sakurai, Chiba-shi (JP); Muneharu Kawana, Chiba-shi (JP); Yoshihisa Tange, Chiba-shi (JP)

Correspondence Address: Brinks Hofer Gilson & Lione/Seiko Instruments Inc., P.O. Box 10395, Chicago, IL, 60611, US

(21) Appl. No.: 12/353,719

(22) Filed: Jan. 14, 2009

(30) Foreign Application Priority Data
Jan. 17, 2008 (JP) JP2008-007774

(51) Int. Cl. H02H 5/04

(52) U.S. Cl. 361/103

(57) ABSTRACT

In order to provide an overheat protection circuit having a small mounting area, the overheat protection circuit includes: a resistor bridge circuit which includes: a plurality of resistors each having a temperature coefficient; an input terminal; and an output terminal; and a comparator circuit connected to the output terminal and the input terminal of the resistor bridge circuit. Parts are each provided in the vicinity of one of the plurality of resistors each having the temperature coefficient, and the comparator circuit outputs an overheat detection signal when a temperature of one of the parts is equal to or higher than an overheat detection temperature. With this structure, a large number of parts can be protected from overheating by a minimum number of overheat protection circuits. Therefore, a circuit scale becomes smaller, and hence a cost for overheat protection becomes lower.

### RELATED APPLICATIONS

This application claims priority under 35 U.S.C. §119 to Japanese Patent Application No. JP2008-007774 filed on Jan. 17, 2008, the entire content of which is hereby incorporated by reference.

### BACKGROUND OF THE INVENTION

1. Field of the Invention

The present invention relates to an overheat protection circuit for protecting a part from overheating.

2. Description of the Related Art

A conventional overheat protection circuit is described. FIG. 12A is a diagram illustrating the conventional overheat protection circuit. FIG. 12B is a graph illustrating a relation between resistance value and temperature of the conventional overheat protection circuit.

As illustrated in FIG. 12B, when a temperature of a part 71 becomes higher, a resistance value of a resistor Rtn61 reduces and, accordingly, a voltage at a non-inverting input terminal of a comparator circuit 65 increases. When the temperature of the part 71 becomes equal to or higher than an overheat detection temperature Ta, a resistance value of a resistor R64 becomes equal to or larger than the resistance value of the resistor Rtn61, and hence the voltage at the non-inverting input terminal of the comparator circuit 65 becomes a high signal. Even when the temperature of the part 71 changes, resistance values of resistors R62 to R64 do not change, and hence a voltage at the inverting input terminal of the comparator circuit 65 does not change. Therefore, the comparator circuit 65 outputs an overheat detection signal (high signal). A control circuit 66 controls a switch circuit 67 in response to the high signal to cut off the power supply to the part 71. Then, the switch circuit 67 is turned off. Thus, the part 71 is protected from overheating (see, for example, JP 04-132967 A).

However, if a system becomes complicated with an increased number of parts on a board, a plurality of overheat protection circuits are required in accordance with the number of parts, which causes a mounting area to become larger.

### SUMMARY OF THE INVENTION

The present invention has been made in view of the problem described above, and has an object to provide an overheat protection circuit having a small mounting area.

In order to solve the above-mentioned problem, there is provided an overheat protection circuit including: a resistor bridge circuit which includes: a plurality of resistors each having a temperature coefficient; an input terminal; and an output terminal; and a comparator circuit connected to the output terminal and the input terminal of the resistor bridge circuit, in which: parts are each provided in the vicinity of one of the plurality of resistors each having the temperature coefficient; and the comparator circuit outputs an overheat detection signal when a temperature of one of the parts is equal to or higher than an overheat detection temperature.

According to the overheat protection circuit of the present invention, a large number of parts can be protected from overheating by a minimum number of overheat protection circuits. Therefore, a circuit scale becomes smaller, and hence a cost for overheat protection becomes lower.

### BRIEF DESCRIPTION OF THE DRAWINGS

In the accompanying drawings:

FIG. 1A is a diagram illustrating an overheat protection circuit according to a first embodiment of the present invention;

FIG. 1B is a graph illustrating a relation between resistance value and temperature of the overheat protection circuit according to the first embodiment of the present invention;

FIG. 2A is a diagram illustrating an overheat protection circuit according to a second embodiment of the present invention;

FIG. 2B is a graph illustrating a relation between resistance value and temperature of the overheat protection circuit according to the second embodiment of the present invention;

FIG. 3A is a diagram illustrating an overheat protection circuit according to a third embodiment of the present invention;

FIG. 3B is a graph illustrating a relation between resistance value and temperature of the overheat protection circuit according to the third embodiment of the present invention;

FIG. 4A is a diagram illustrating an overheat protection circuit according to a fourth embodiment of the present invention;

FIG. 4B is a graph illustrating a relation between resistance value and temperature of the overheat protection circuit according to the fourth embodiment of the present invention;

FIG. 5A is a diagram illustrating an overheat protection circuit according to a fifth embodiment of the present invention;

FIG. 5B is a graph illustrating a relation between resistance value and temperature of the overheat protection circuit according to the fifth embodiment of the present invention;

FIG. 6A is a diagram illustrating an overheat protection circuit according to a sixth embodiment of the present invention;

FIG. 6B is a graph illustrating a relation between resistance value and temperature of the overheat protection circuit according to the sixth embodiment of the present invention;

FIG. 7A is a diagram illustrating an overheat protection circuit according to a seventh embodiment of the present invention;

FIG. 7B is a graph illustrating a relation between resistance value and temperature of the overheat protection circuit according to the seventh embodiment of the present invention;

FIG. 8A is a diagram illustrating an overheat protection circuit according to an eighth embodiment of the present invention;

FIG. 8B is a graph illustrating a relation between resistance value and temperature of the overheat protection circuit according to the eighth embodiment of the present invention;

FIG. 9A is a diagram illustrating an overheat protection circuit according to a ninth embodiment of the present invention;

FIG. 9B is a graph illustrating a relation between resistance value and temperature of the overheat protection circuit according to the ninth embodiment of the present invention;

FIG. 10A is a diagram illustrating an overheat protection circuit according to a tenth embodiment of the present invention;

FIG. 10B is a graph illustrating a relation between resistance value and temperature of the overheat protection circuit according to the tenth embodiment of the present invention;

FIG. 11A is a diagram illustrating an overheat protection circuit according to an eleventh embodiment of the present invention;

FIG. 11B is a graph illustrating a relation between resistance value and temperature of the overheat protection circuit according to the eleventh embodiment of the present invention;

FIG. 12A is a diagram illustrating a conventional overheat protection circuit; and

FIG. 12B is a graph illustrating a relation between resistance value and temperature of the overheat protection circuit according to the conventional overheat protection circuit.

### DETAILED DESCRIPTION OF THE PREFERRED EMBODIMENTS

Hereinafter, embodiments of the present invention are described with reference to the attached drawings.

### First Embodiment

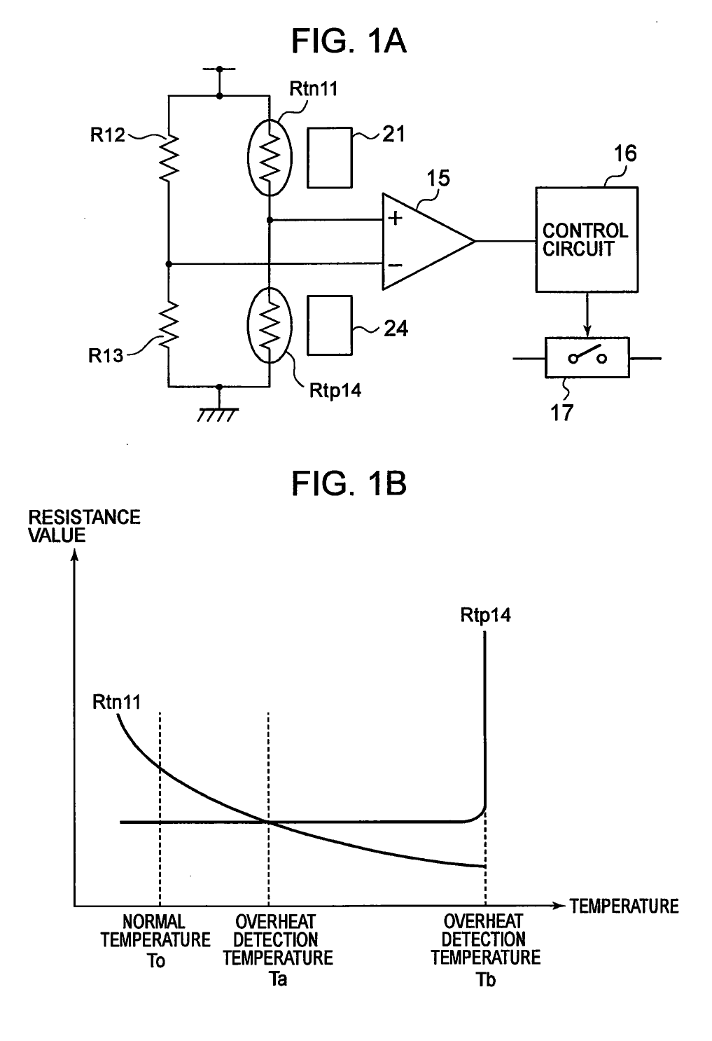

A structure of an overheat protection circuit according to a first embodiment of the present invention is described. FIG. 1A is a diagram illustrating the overheat protection circuit according to the first embodiment of the present invention. FIG. 1B is a graph illustrating a relation between resistance value and temperature of the overheat protection circuit according to the first embodiment of the present invention.

As illustrated in FIG. 1A, the overheat protection circuit includes a resistor Rtn11, a resistor R12, a resistor R13, a resistor Rtp14, a comparator circuit 15, a control circuit 16, and a switch circuit 17. A part 21 is provided in the vicinity of the resistor Rtn11. A part 24 is provided in the vicinity of the resistor Rtp14.

One end of the resistor Rtn11 is provided at a power source terminal and the other end thereof is provided at a non-inverting input terminal of the comparator circuit 15. One end of the resistor R12 is provided at the power source terminal and the other end thereof is provided at an inverting input terminal of the comparator circuit 15. One end of the resistor R13 is provided at a ground terminal and the other end thereof is provided at the inverting input terminal of the comparator circuit 15. One end of the resistor Rtp14 is provided at the ground terminal and the other end thereof is provided at the non-inverting input terminal of the comparator circuit 15. The resistor Rtn11, the resistor R12, the resistor R13, and the resistor Rtp14 serve as a bridge circuit. An input terminal of the control circuit 16 is provided at an output terminal of the comparator circuit 15 and output terminal thereof is provided at an input terminal of the switch circuit 17. The switch circuit 17 is provided on a power supply line to be able to cut off the power supply. The part 21 is provided in the vicinity of the resistor Rtn11. The part 24 is provided in the vicinity of the resistor Rtp14.

The resistor Rtn11 has a negative temperature coefficient. The resistors R12 and R13 have no temperature coefficient. The resistor Rtp14 has a positive temperature coefficient. Resistance values of the respective resistors serving as the bridge circuit are set such that a low signal is output from the output terminal of the comparator circuit 15 at normal temperature. To be specific, the circuit is designed such that a value obtained by multiplying the resistance value of the resistor Rtn11 by the resistance value of the resistor R13 is larger than a value obtained by multiplying the resistance value of the resistor R12 by the resistance value of the resistor Rtp14 at normal temperature.

The comparator circuit 15 and the control circuit 16 are included in a single semiconductor device. The semiconductor device, the resistor Rtn11, the resistor R12, the resistor R13, the resistor Rtp14, the part 21, the part 24, and the switch circuit 17 are separately mounted on a board.

Next, an operation of the overheat protection circuit according to the first embodiment of the present invention is described.

<Case where Temperature of Part 21 Increases>

As illustrated in FIG. 1B, the resistance value of the resistor Rtn11 reduces and, accordingly, the voltage at the non-inverting input terminal of the comparator circuit 15 increases. When the temperature of the part 21 becomes equal to or higher than an overheat detection temperature Ta, the resistance value of the resistor Rtp14 becomes equal to or larger than the resistance value of the resistor Rtn11, and hence the voltage at the non-inverting input terminal of the comparator circuit 15 becomes a high signal. Even when the temperature of the part 21 changes, the resistance values of the resistors R12 and R13 do not change, and hence the voltage at the inverting input terminal of the comparator circuit 15 does not change. Therefore, the comparator circuit 15 outputs an overheat detection signal (high signal). The control circuit 16 controls the switch circuit 17 in response to the high signal to cut off the power supply to the parts 21 and 24. Then, the switch circuit 17 is turned off. Thus, the parts 21 and 24 are protected from overheating.

<Case where Temperature of Part 24 Increases>

The resistance value of the resistor Rtp14 hardly changes and the voltage at the non-inverting input terminal of the comparator circuit 15 hardly changes. When the temperature of the part 24 becomes equal to or higher than an overheat detection temperature Tb, the resistance value of the resistor Rtp14 rapidly increases, and thus the resistance value of the resistor Rtp14 becomes equal to or larger than the resistance value of the resistor Rtn11. Accordingly, the voltage at the non-inverting input terminal of the comparator circuit 15 becomes the high signal. Then, the switch circuit 17 is turned off. Therefore, the part 21 and the part 24 are protected from overheating.

With this configuration, a plurality of parts (parts 21 and 24) are protected from overheating by not a plurality of overheat protection circuits but a single overheat protection circuit, and hence a mounting area becomes smaller and a manufacturing cost for overheating protection reduces.

The states in which the temperatures of the parts 21 and 24 are equal to or higher than the overheat detection temperatures are detected without using a reference voltage of a reference voltage circuit. Therefore, a circuit scale reduces, and hence a circuit area and the power consumption become smaller.

In addition, the two overheat detection temperatures, that is, the overheat detection temperature Ta and the overheat detection temperature Tb are provided, and hence the overheat protection circuit can deal with heat resistances of the two parts.

The comparator circuit 15 and the control circuit 16 is configured as a single semiconductor device, but the comparator circuit 15, the control circuit 16, and the switch circuit 17 may be configured as a single semiconductor device.

Further, the resistor Rtp14 is provided, but the resistor Rtp14 may include a plurality of resistors (not shown) which have positive temperature coefficients and are connected in series. In this case, the plurality of resistors are provided in the vicinity of a plurality of corresponding parts (not shown). Therefore, more parts are protected from overheating, with the result that the mounting area becomes smaller.

The switch circuit 17 is provided to cut off the power supply to the parts 24 and 21. However, this embodiment is not limited to such a case. Any configuration is applicable as long as the operations of the parts 24 and 21 are stopped.

### Second Embodiment

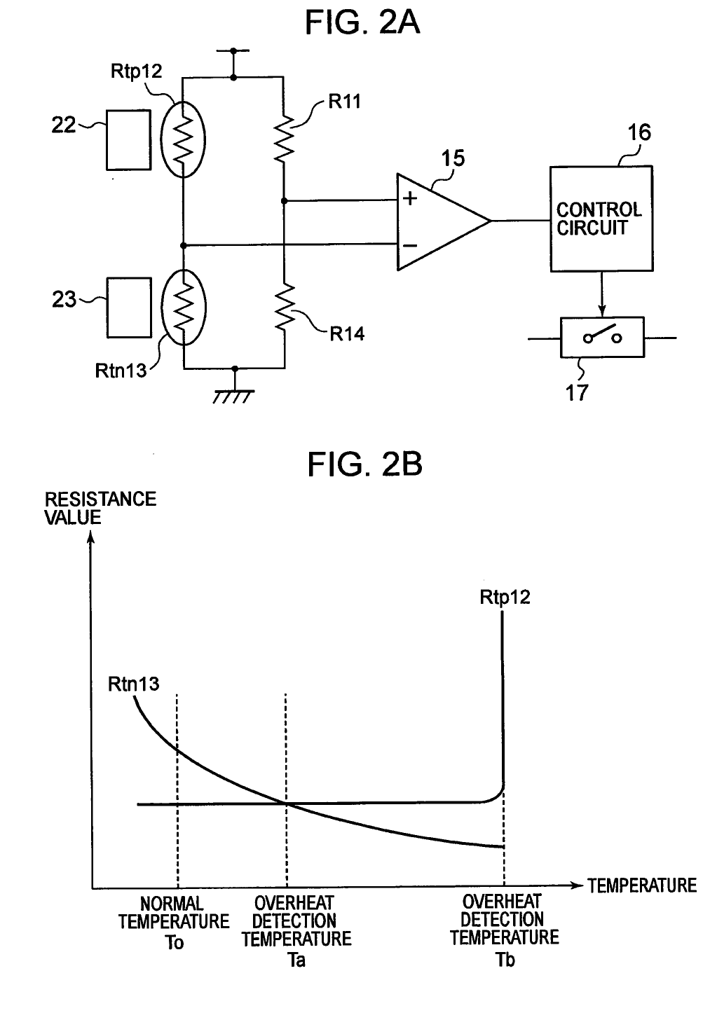

A structure of an overheat protection circuit according to a second embodiment of the present invention is described. FIG. 2A is a diagram illustrating the overheat protection circuit according to the second embodiment of the present invention. FIG. 2B is a graph illustrating a relation between resistance value and temperature of the overheat protection circuit according to the second embodiment of the present invention.

As illustrated in FIG. 2A, the overheat protection circuit according to the second embodiment of the present invention is different from the overheat protection circuit according to the first embodiment of the present invention in that the resistor Rtn11 is changed to a resistor R11, the resistor R12 is changed to a resistor Rtp12, the resistor R13 is changed to a resistor Rtn13, and the resistor Rtp14 is changed to a resistor R14. In addition, the part 21 is removed, a part 22 is provided in the vicinity of the resistor Rtp12, a part 23 is provided in the vicinity of the resistor Rtn13, and the part 24 is removed.

The resistor R11 has no temperature coefficient. The resistor Rtp12 has a positive temperature coefficient. The resistor Rtn13 has a negative temperature coefficient. The resistor R14 has no temperature coefficient. Resistance values of the respective resistors serving as the bridge circuit are set such that a low signal is output from the output terminal of the comparator circuit 15 at normal temperature. To be specific, the circuit is designed such that a value obtained by multiplying the resistance value of the resistor R11 by the resistance value of the resistor Rtn13 is larger than a value obtained by multiplying the resistance value of the resistor Rtp12 by the resistance value of the resistor R14 at normal temperature.

Next, an operation of the overheat protection circuit according to the second embodiment of the present invention is described.

<Case where Temperature of Part 23 Increases>

As illustrated in FIG. 2B, the resistance value of the resistor Rtn13 reduces and, accordingly, the voltage at the inverting input terminal of the comparator circuit 15 increases. When the temperature of the part 23 becomes equal to or higher than the overheat detection temperature Ta, the resistance value of the resistor Rtp12 becomes equal to or larger than the resistance value of the resistor Rtn13, and hence the voltage at the inverting input terminal of the comparator circuit 15 becomes a low signal. Then, the switch circuit 17 is turned off. Thus, the parts 22 and 23 are protected from overheating.

<Case where Temperature of Part 22 Increases>

The resistance value of the resistor Rtp12 hardly changes and the voltage at the inverting input terminal of the comparator circuit 15 hardly changes. When the temperature of the part 22 becomes equal to or higher than an overheat detection temperature Tb, the resistance value of the resistor Rtp12 rapidly increases, and thus the resistance value of the resistor Rtp12 becomes equal to or larger than the resistance value of the resistor Rtn13. Accordingly, the voltage at the inverting input terminal of the comparator circuit 15 becomes the low signal. Then, the switch circuit 17 is turned off. Therefore, the part 22 and the part 23 are protected from overheating.

### Third Embodiment

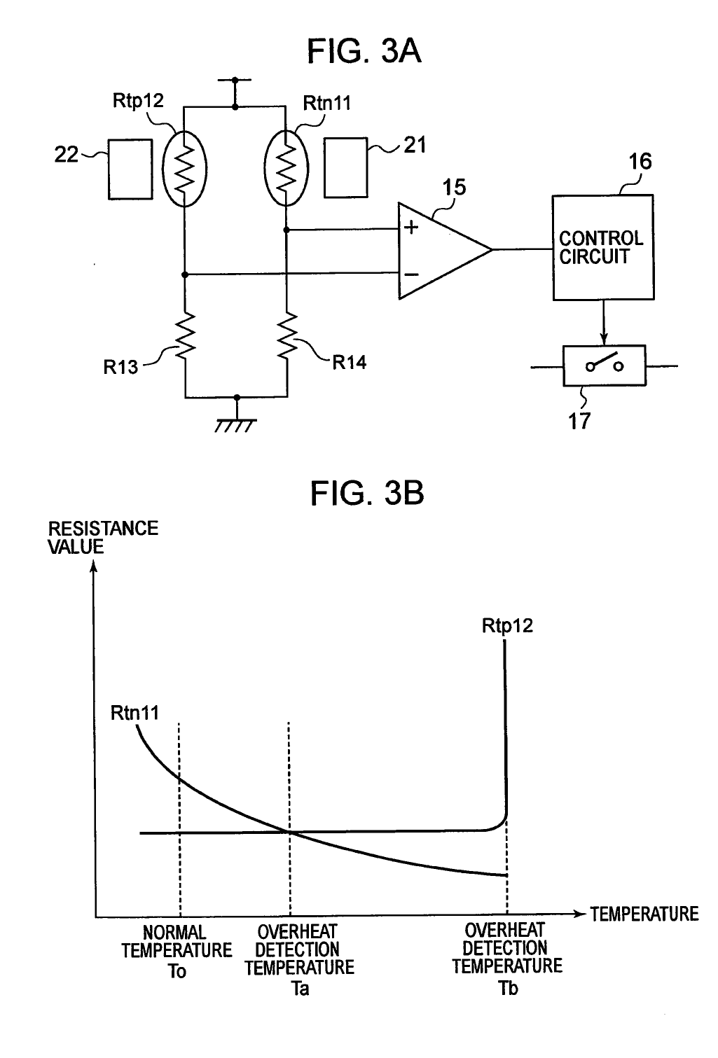

Next, a structure of an overheat protection circuit according to a third embodiment of the present invention is described. FIG. 3A is a diagram illustrating the overheat protection circuit according to the third embodiment of the present invention. FIG. 3B is a graph illustrating a relation between resistance value and temperature of the overheat protection circuit according to the third embodiment of the present invention.

As illustrated in FIG. 3A, the overheat protection circuit according to the third embodiment of the present invention is different from the overheat protection circuit according to the first embodiment of the present invention in that the resistor R12 is changed to the resistor Rtp12, and the resistor Rtp14 is changed to the resistor R14. In addition, the part 22 is provided in the vicinity of the resistor Rtp12, and the part 24 is removed.

The resistor Rtn11 has a negative temperature coefficient. The resistor Rtp12 has a positive temperature coefficient. The resistors R13 and R14 have no temperature coefficient. Resistance values of the respective resistors serving as the bridge circuit are set such that a low signal is output from the output terminal of the comparator circuit 15 at normal temperature. To be specific, the circuit is designed such that a value obtained by multiplying the resistance value of the resistor Rtn11 by the resistance value of the resistor R13 is larger than a value obtained by multiplying the resistance value of the resistor Rtp12 by the resistance value of the resistor R14 at normal temperature.

Next, an operation of the overheat protection circuit according to the third embodiment of the present invention is described.

<Case where Temperature of Part 21 Increases>

The overheat protection circuit operates as described above, and hence the parts 21 and 22 are protected from overheating.

<Case where Temperature of Part 22 Increases>

The overheat protection circuit operates as described above, and hence the parts 21 and 22 are protected from overheating.

### Fourth Embodiment

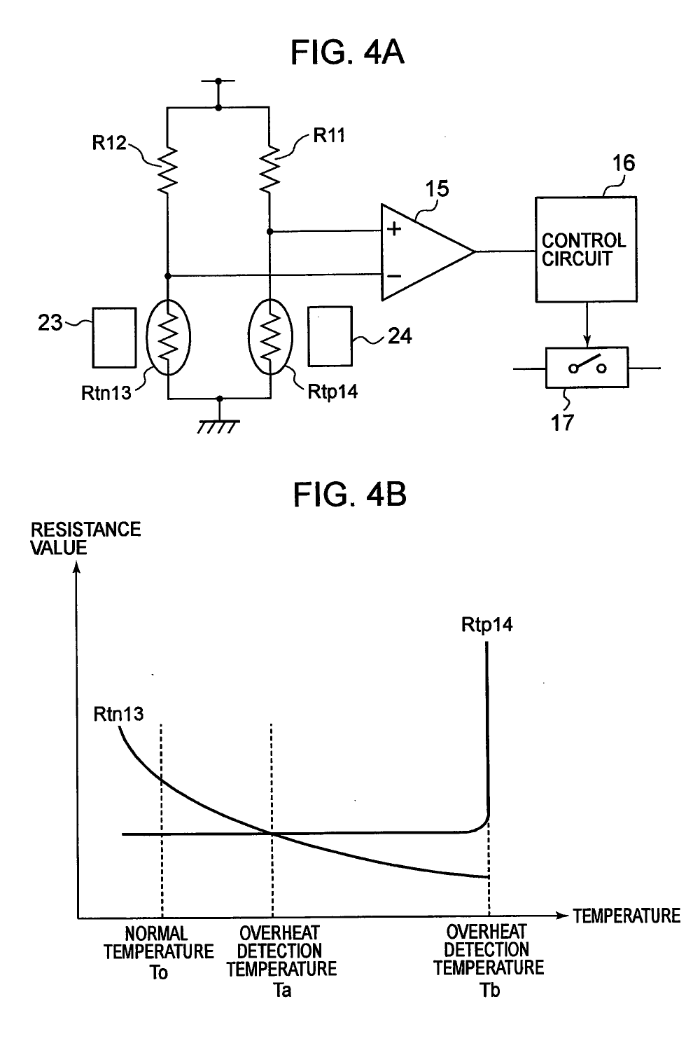

Next, a structure of an overheat protection circuit according to a fourth embodiment of the present invention is described. FIG. 4A is a diagram illustrating the overheat protection circuit according to the fourth embodiment of the present invention. FIG. 4B is a graph illustrating a relation between resistance value and temperature of the overheat protection circuit according to the fourth embodiment of the present invention.

As illustrated in FIG. 4A, the overheat protection circuit according to the fourth embodiment of the present invention is different from the overheat protection circuit according to the first embodiment of the present invention in that the resistor Rtn11 is changed to the resistor R11, and the resistor R13 is changed to the resistor Rtn13. In addition, the part 21 is removed, and the part 23 is provided in the vicinity of the resistor Rtn13.

The resistors R11 and R12 have no temperature coefficients. The resistor Rtn13 has a negative temperature coefficient. The resistor Rtp14 has a positive temperature coefficient. Resistance values of the respective resistors serving as the bridge circuit are set such that a low signal is output from the output terminal of the comparator circuit 15 at normal temperature. To be specific, the circuit is designed such that a value obtained by multiplying the resistance value of the resistor R11 by the resistance value of the resistor Rtn13 is larger than a value obtained by multiplying the resistance value of the resistor R12 by the resistance value of the resistor Rtp14 at normal temperature.

Next, an operation of the overheat protection circuit according to the fourth embodiment of the present invention is described.

<Case where Temperature of Part 23 Increases>

The overheat protection circuit operates as described above, and hence the parts 23 and 24 are protected from overheating.

<Case where Temperature of Part 24 Increases>

The overheat protection circuit operates as described above, and hence the part 23 and the part 24 are protected from overheating.

### Fifth Embodiment

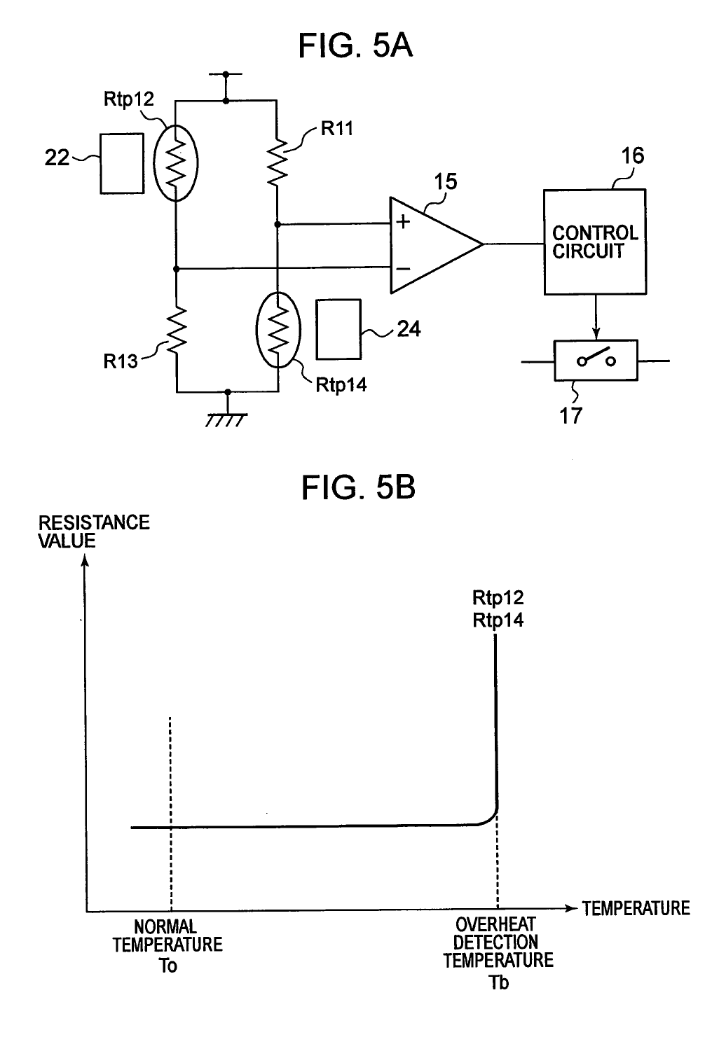

Next, a structure of an overheat protection circuit according to a fifth embodiment of the present invention is described. FIG. 5A is a diagram illustrating the overheat protection circuit according to the fifth embodiment of the present invention. FIG. 5B is a graph illustrating a relation between resistance value and temperature of the overheat protection circuit according to the fifth embodiment of the present invention.

As illustrated in FIG. 5A, the overheat protection circuit according to the fifth embodiment of the present invention is different from the overheat protection circuit according to the first embodiment of the present invention in that the resistor Rtn11 is changed to the resistor R11, and the resistor R12 is changed to the resistor Rtp12. In addition, the part 21 is removed, and the part 22 is provided in the vicinity of the resistor Rtp12.

The resistor R11 has no temperature coefficient. The resistor Rtp12 has a positive temperature coefficient. The resistor R13 has no temperature coefficient. The resistor Rtp14 has a positive temperature coefficient. Resistance values of the respective resistors serving as the bridge circuit are set such that a low signal is output from the output terminal of the comparator circuit 15 at normal temperature. To be specific, the circuit is designed such that a value obtained by multiplying the resistance value of the resistor R11 by the resistance value of the resistor R13 is larger than a value obtained by multiplying the resistance value of the resistor Rtp12 by the resistance value of the resistor Rtp14 at normal temperature.

Next, an operation of the overheat protection circuit according to the fifth embodiment of the present invention is described.

<Case where Temperature of Part 22 Increases>

The overheat protection circuit operates as described above, and hence the parts 22 and 24 are protected from overheating.

<Case where Temperature of Part 24 Increases>

The overheat protection circuit operates as described above, and hence the parts 22 and 24 are protected from overheating.

The heat resistances of the parts 22 and 24 are equal to each other, and hence the temperature coefficients of the resistors Rtp12 and Rtp14 are equal to each other. However, when the heat resistances of the parts 22 and 24 are different from each other, the temperature coefficients of the resistors Rtp12 and Rtp14 may be made different from each other based on the heat resistances. To be specific, the overheat detection temperatures of the resistors Rtp12 and Rtp14 may be different from each other.

### Sixth Embodiment

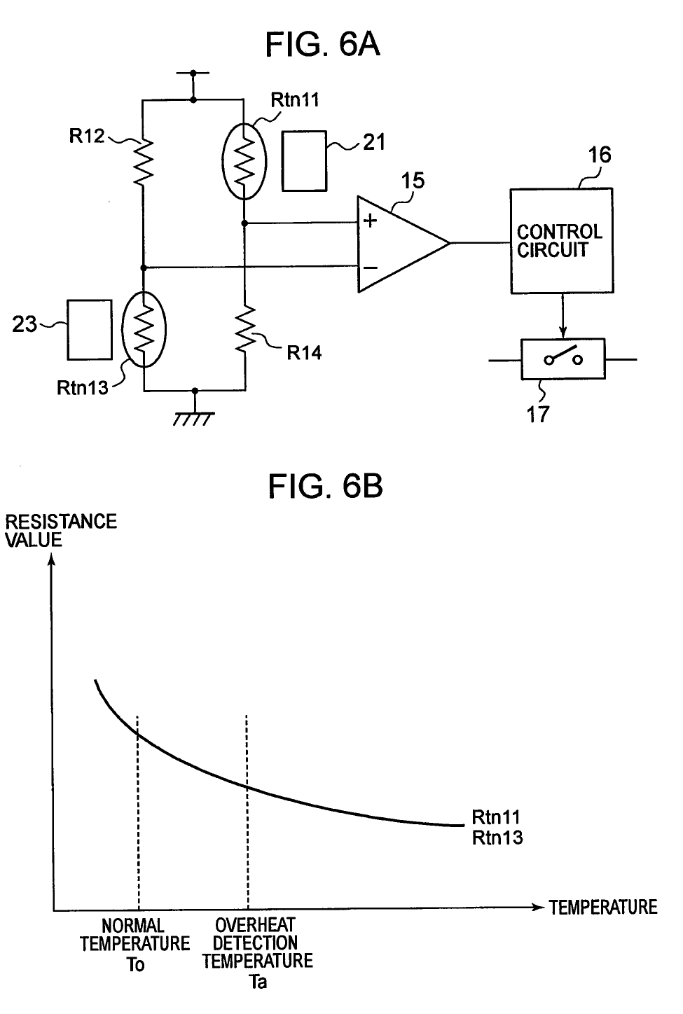

Next, a structure of an overheat protection circuit according to a sixth embodiment of the present invention is described. FIG. 6A is a diagram illustrating the overheat protection circuit according to the sixth embodiment of the present invention. FIG. 6B is a graph illustrating a relation between resistance value and temperature of the overheat protection circuit according to the sixth embodiment of the present invention.

As illustrated in FIG. 6A, the overheat protection circuit according to the sixth embodiment of the present invention is different from the overheat protection circuit according to the first embodiment of the present invention in that the resistor R13 is changed to the resistor Rtn13 and the resistor Rtp14 is changed to the resistor R14. In addition, the part 23 is provided in the vicinity of the resistor Rtn13, and the part 24 is removed.

The resistor Rtn11 has a negative temperature coefficient. The resistor R12 has no temperature coefficient. The resistor Rtn13 has a negative temperature coefficient. The resistor R14 has no temperature coefficient. Resistance values of the respective resistors serving as the bridge circuit are set such that a low signal is output from the output terminal of the comparator circuit 15 at normal temperature. To be specific, the circuit is designed such that a value obtained by multiplying the resistance value of the resistor Rtn11 by the resistance value of the resistor Rtn13 is larger than a value obtained by multiplying the resistance value of the resistor R12 by the resistance value of the resistor R14 at normal temperature.

Next, an operation of the overheat protection circuit according to the sixth embodiment of the present invention is described.

<Case where Temperature of Part 21 Increases>

The overheat protection circuit operates as described above, and hence the parts 21 and 23 are protected from overheating.

<Case where Temperature of Part 23 Increases>

The overheat protection circuit operates as described above, and hence the parts 21 and 23 are protected from overheating.

It should be noted that the overheat detection temperatures of the resistors Rtn11 and Rtn13 may be different from each other.

### Seventh Embodiment

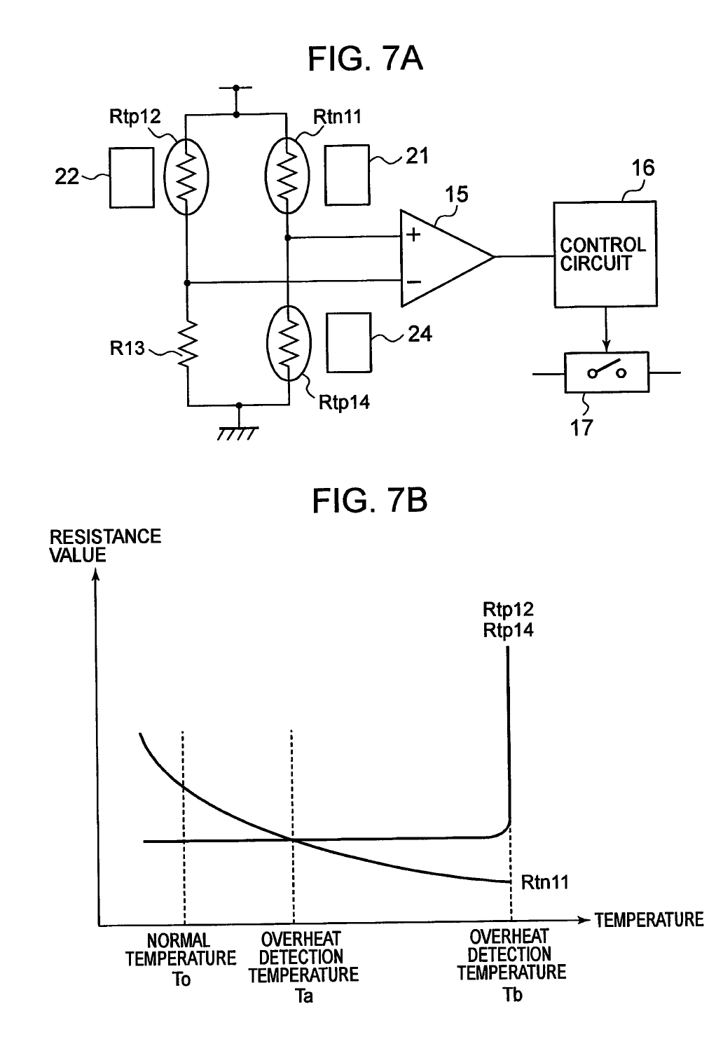

Next, a structure of an overheat protection circuit according to a seventh embodiment of the present invention is described. FIG. 7A is a diagram illustrating the overheat protection circuit according to the seventh embodiment of the present invention. FIG. 7B is a graph illustrating a relation between resistance value and temperature of the overheat protection circuit according to the seventh embodiment of the present invention.

As illustrated in FIG. 7A, the overheat protection circuit according to the seventh embodiment of the present invention is different from the overheat protection circuit according to the first embodiment of the present invention in that the resistor R12 is changed to the resistor Rtp12. In addition, the part 22 is provided in the vicinity of the resistor Rtp12.

The resistor Rtn11 has a negative temperature coefficient. The resistor Rtp12 has a positive temperature coefficient. The resistor R13 has no temperature coefficient. The resistor Rtp14 has a positive temperature coefficient. Resistance values of the respective resistors serving as the bridge circuit are set such that a low signal is output from the output terminal of the comparator circuit 15 at normal temperature. To be specific, the circuit is designed such that a value obtained by multiplying the resistance value of the resistor Rtn11 by the resistance value of the resistor R13 is larger than a value obtained by multiplying the resistance value of the resistor Rtp12 by the resistance value of the resistor Rtp14 at normal temperature.

Next, an operation of the overheat protection circuit according to the seventh embodiment of the present invention is described.

<Case where Temperature of Part 21 Increases>

The overheat protection circuit operates as described above, and hence the parts 21, 22, and 24 are protected from overheating.

<Case where Temperature of Part 22 Increases>

The overheat protection circuit operates as described above, and hence the parts 21, 22, and 24 are protected from overheating.

<Case where Temperature of Part 24 Increases>

The overheat protection circuit operates as described above, and hence the parts 21, 22, and 24 are protected from overheating.

It should be noted that the overheat detection temperatures of the resistors Rtp12 and Rtp14 may be different from each other.

### Eighth Embodiment

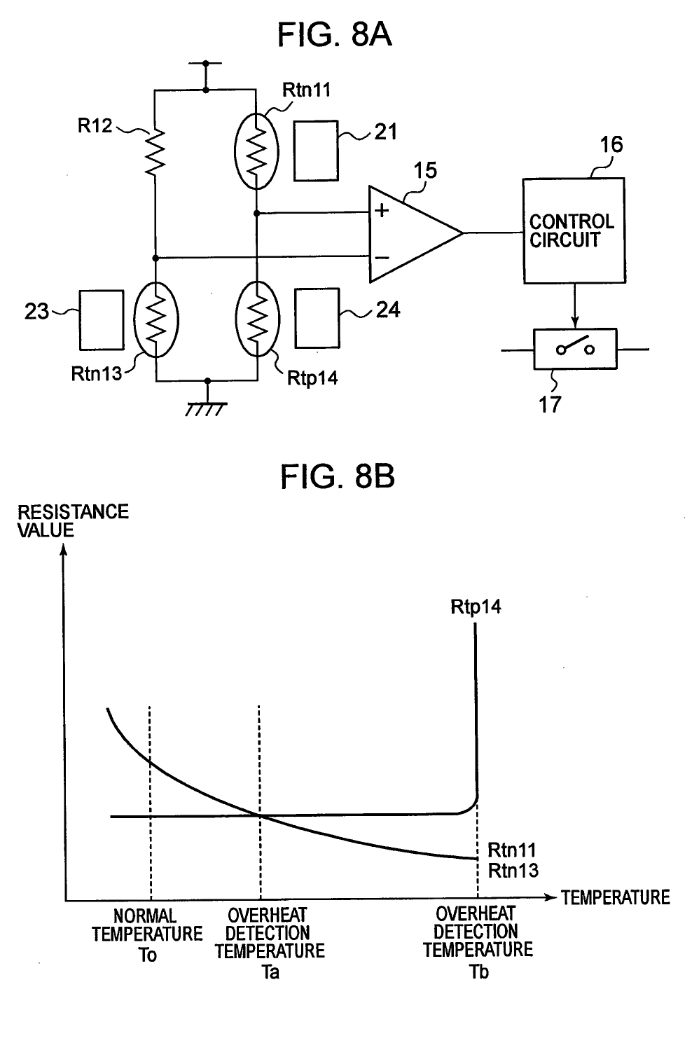

Next, a structure of an overheat protection circuit according to an eighth embodiment of the present invention is described. FIG. 8A is a diagram illustrating the overheat protection circuit according to the eighth embodiment of the present invention. FIG. 8B is a graph illustrating a relation between resistance value and temperature of the overheat protection circuit according to the eighth embodiment of the present invention.

As illustrated in FIG. 8A, the overheat protection circuit according to the eighth embodiment of the present invention is different from the overheat protection circuit according to the first embodiment of the present invention in that the resistor R13 is changed to the resistor Rtn13. In addition, the part 23 is provided in the vicinity of the resistor Rtn13.

The resistor Rtn11 has a negative temperature coefficient. The resistor R12 has no temperature coefficient. The resistor Rtn13 has a negative temperature coefficient. The resistor Rtp14 has a positive temperature coefficient. Resistance values of the respective resistors serving as the bridge circuit are set such that a low signal is output from the output terminal of the comparator circuit 15 at normal temperature. To be specific, the circuit is designed such that a value obtained by multiplying the resistance value of the resistor Rtn11 by the resistance value of the resistor Rtn13 is larger than a value obtained by multiplying the resistance value of the resistor R12 by the resistance value of the resistor Rtp14 at normal temperature.

Next, an operation of the overheat protection circuit according to the eighth embodiment of the present invention is described.

<Case where Temperature of Part 21 Increases>

The overheat protection circuit operates as described above, and hence the parts 21, 23, and 24 are protected from overheating.

<Case where Temperature of Part 23 Increases>

The overheat protection circuit operates as described above, and hence the parts 21, 23, and 24 are protected from overheating.

<Case where Temperature of Part 24 Increases>

The overheat protection circuit operates as described above, and hence the parts 21, 23, and 24 are protected from overheating.

It should be noted that the overheat detection temperatures of the resistors Rtn11 and Rtn13 may be different from each other.

### Ninth Embodiment

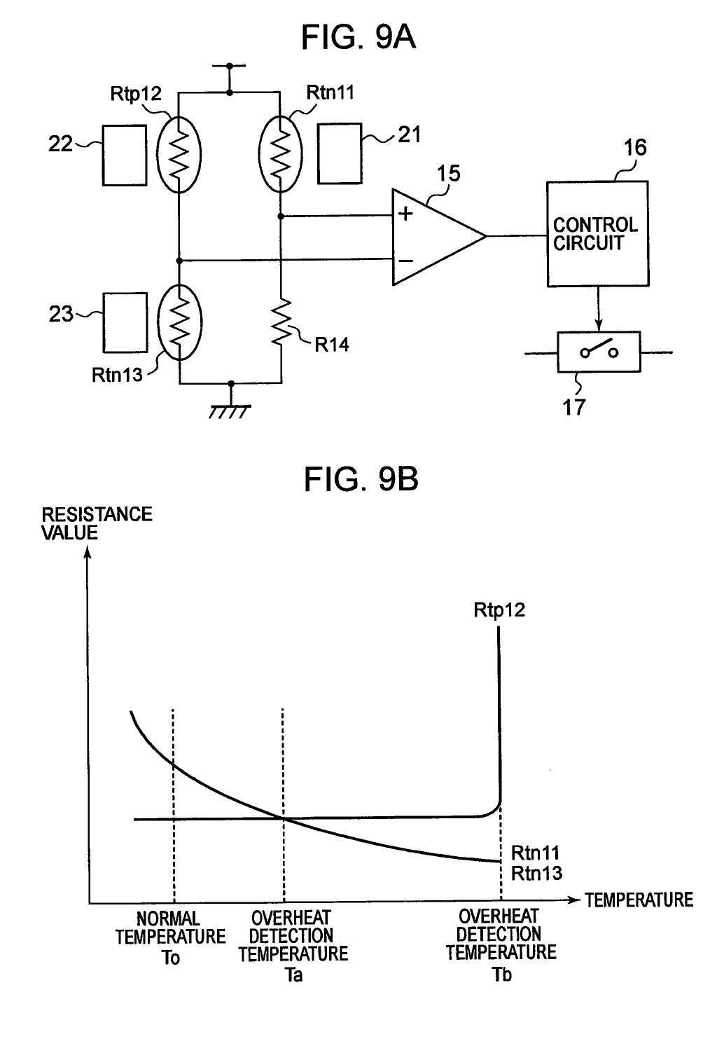

Next, a structure of an overheat protection circuit according to a ninth embodiment of the present invention is described. FIG. 9A is a diagram illustrating the overheat protection circuit according to the ninth embodiment of the present invention. FIG. 9B is a graph illustrating a relation between resistance value and temperature of the overheat protection circuit according to the ninth embodiment of the present invention.

As illustrated in FIG. 9A, the overheat protection circuit according to the ninth embodiment of the present invention is different from the overheat protection circuit according to the second embodiment of the present invention in that the resistor R11 is changed to the resistor Rtn11. In addition, the part 21 is provided in the vicinity of the resistor Rtn11.

The resistor Rtn11 has a negative temperature coefficient. The resistor Rtp12 has a positive temperature coefficient. The resistor Rtn13 has a negative temperature coefficient. The resistor R14 has no temperature coefficient. Resistance values of the respective resistors serving as the bridge circuit are set such that a low signal is output from the output terminal of the comparator circuit 15 at normal temperature. To be specific, the circuit is designed such that a value obtained by multiplying the resistance value of the resistor Rtn11 by the resistance value of the resistor Rtn13 is larger than a value obtained by multiplying the resistance value of the resistor Rtp12 by the resistance value of the resistor R14 at normal temperature.

Next, an operation of the overheat protection circuit according to the ninth embodiment of the present invention is described.

<Case where Temperature of Part 21 Increases>

The overheat protection circuit operates as described above, and hence the parts 21, 22, and 23 are protected from overheating.

<Case where Temperature of Part 23 Increases>

The overheat protection circuit operates as described above, and hence the parts 21, 22, and 23 are protected from overheating.

<Case where Temperature of Part 22 Increases>

The overheat protection circuit operates as described above, and hence the parts 21, 22, and 23 are protected from overheating.

It should be noted that the overheat detection temperatures of the resistors Rtn11 and Rtn13 may be different from each other.

### Tenth Embodiment

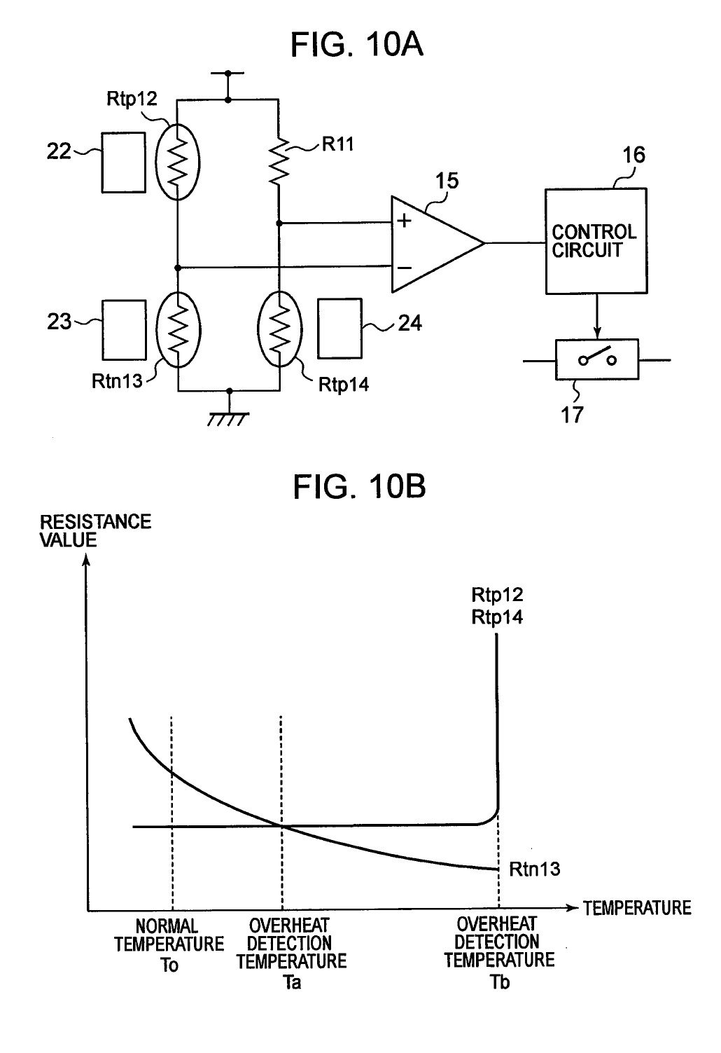

Next, a structure of an overheat protection circuit according to a tenth embodiment of the present invention is described. FIG. 10A is a diagram illustrating the overheat protection circuit according to the tenth embodiment of the present invention. FIG. 10B is a graph illustrating a relation between resistance value and temperature of the overheat protection circuit according to the tenth embodiment of the present invention.

As illustrated in FIG. 10A, the overheat protection circuit according to the tenth embodiment of the present invention is different from the overheat protection circuit according to the second embodiment of the present invention in that the resistor R14 is changed to the resistor Rtp14. In addition, the part 24 is provided in the vicinity of the resistor Rtp14.

The resistor R11 has no temperature coefficient. The resistor Rtp12 has a positive temperature coefficient. The resistor Rtn13 has a negative temperature coefficient. The resistor Rtp14 has a positive coefficient. Resistance values of the respective resistors serving as the bridge circuit are set such that a low signal is output from the output terminal of the comparator circuit 15 at normal temperature. To be specific, the circuit is designed such that a value obtained by multiplying the resistance value of the resistor R11 by the resistance value of the resistor Rtn13 is larger than a value obtained by multiplying the resistance value of the resistor Rtp12 by the resistance value of the resistor Rtp14 at normal temperature.

Next, an operation of the overheat protection circuit according to the tenth embodiment of the present invention is described.

<Case where Temperature of Part 23 Increases>

The overheat protection circuit operates as described above, and hence the parts 22, 23, and 24 are protected from overheating.

<Case where Temperature of Part 22 Increases>

The overheat protection circuit operates as described above, and hence the parts 22, 23, and 24 are protected from overheating.

<Case where Temperature of Part 24 Increases>

The overheat protection circuit operates as described above, and hence the parts 22, 23, and 24 are protected from overheating.

It should be noted that the overheat detection temperatures of the resistors Rtp12 and Rtp14 may be different from each other.

### Eleventh Embodiment

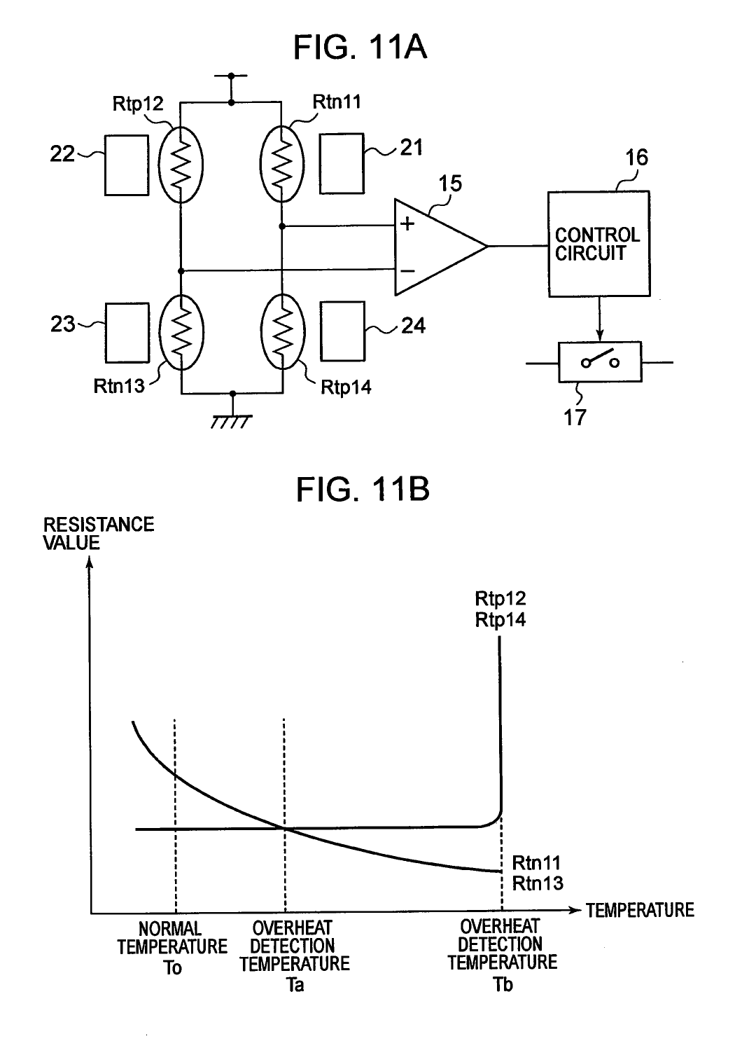

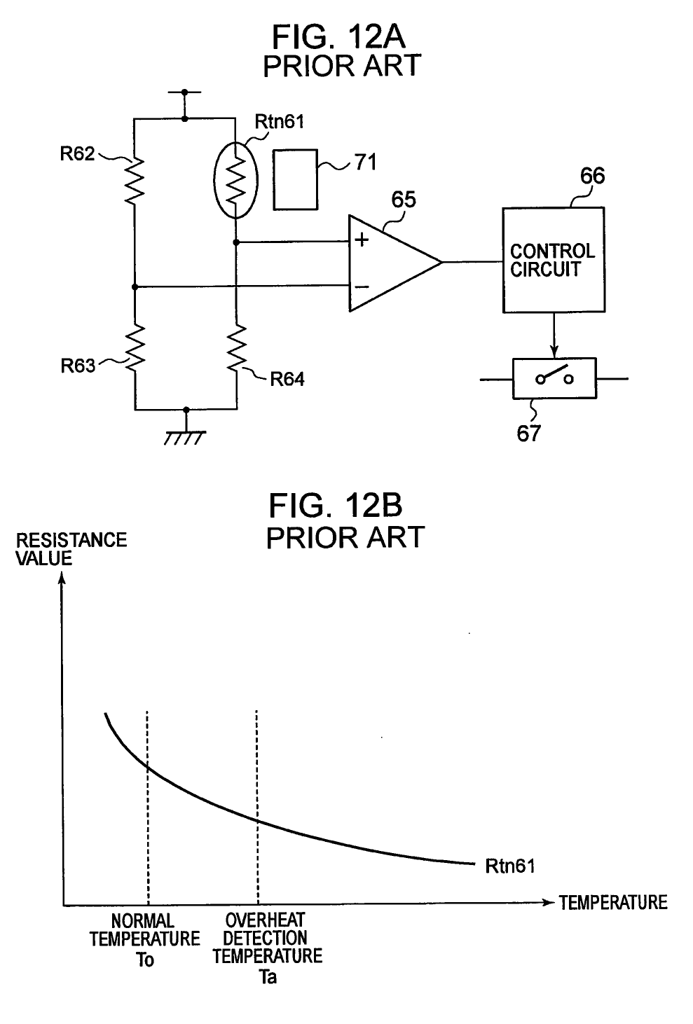

Next, a structure of an overheat protection circuit according to an eleventh embodiment of the present invention is described. FIG. 11A is a diagram illustrating the overheat protection circuit according to the eleventh embodiment of the present invention. FIG. 11B is a graph illustrating a relation between resistance value and temperature of the overheat protection circuit according to the eleventh embodiment of the present invention.

As illustrated in FIG. 11A, the overheat protection circuit according to the eleventh embodiment of the present invention is different from the overheat protection circuit according to the first embodiment of the present invention in that the resistor R12 is changed to the resistor Rtp12 and the resistor R13 is changed to the resistor Rtn13. In addition, the part 22 is provided in the vicinity of the resistor Rtp12.

The resistor Rtn11 has a negative temperature coefficient. The resistor Rtp12 has a positive temperature coefficient. The resistor Rtn13 has a negative coefficient. The resistor Rtp14 has a positive coefficient. Resistance values of the respective resistors serving as the bridge circuit are set such a low signal is output from the output terminal of the comparator circuit 15 at normal temperature. To be specific, the circuit is designed such that a value obtained by multiplying the resistance value of the resistor Rtn11 by the resistance value of the resistor Rtn13 is larger than a value obtained by multiplying the resistance value of the resistor Rtp12 by the resistance value of the resistor Rtp14 at normal temperature.

Next, an operation of the overheat protection circuit according to the eleventh embodiment of the present invention is described.

<Case where Temperature of Part 21 Increases>

The overheat protection circuit operates as described above, and hence the parts 21, 22, 23, and 24 are protected from overheating.

<Case where Temperature of Part 23 Increases>

The overheat protection circuit operates as described above, and hence the parts 21, 22, 23, and 24 are protected from overheating.

<Case where Temperature of Part 22 Increases>

The overheat protection circuit operates as described above, and hence the parts 21, 22, 23, and 24 are protected from overheating.

<Case where Temperature of Part 24 Increases>

The overheat protection circuit operates as described above, and hence the parts 21, 22, 23, and 24 are protected from overheating.

The temperature coefficients of the resistors Rtn11 and Rtn13 may be different from each other. The temperature coefficients of the resistors Rtp12 and Rtp14 may be different from each other.

What is claimed is:

1. An overheat protection circuit, comprising:
a resistor bridge circuit which includes:
a plurality of resistors each having a temperature coefficient;
an input terminal; and
an output terminal; and
a comparator circuit connected to the output terminal and the input terminal of the resistor bridge circuit, wherein:
parts are each provided in the vicinity of one of the plurality of resistors each having the temperature coefficient; and
the comparator circuit outputs an overheat detection signal when a temperature of one of the parts is equal to or higher than an overheat detection temperature.

2. An overheat protection circuit according to claim 1, wherein at least one of the plurality of resistors each having the temperature coefficient comprises a plurality of resistors connected in series.
